(19) United States
(12) Patent Application Publication
(10) Pub. No.: US 2022/0328209 A1
(43) Pub. Date: Oct. 13, 2022

(54) Cooling Systems and Methods for Nuclear Thermionic Avalanche Cells

(71) Applicant: Robert W. Moses, Poquoson, VA (US)

(72) Inventor: Robert W. Moses, Poquoson, VA (US)

(21) Appl. No.: 17/227,122

(22) Filed: Apr. 9, 2021

(51) Int. Cl. G21H 1/10; G21H 1/04

(52) U.S. Cl. CPC G21H 1/106; G21H 1/04; G21H 1/103

(57) ABSTRACT

A cooling system and method for Nuclear Thermionic Avalanche Cells (NT A Cs) Through cooling channels disposed within layers of the NTAC. The NTAC uses gamma ray radiations and/or energetic electrons which are emanated from the decay processes of radioactive materials 5 and operates continuously. The cooling system and method maximizes energy output of current NTAC devices, alleviates thermal loading issues inside a NTAC. The cooling system and method may also include radiative means for dissipating thermal energy, or in other embodiments capture thermal energy from a NTAC in addition to electrical energy generated by NTACs. Cooling channels are disposed within the layers of a NTAC and joined to a fluid and/or gas flow control system through top and bottom structures which incorporate cooling channels and allow fluid and/or gas to flow through the layers of a NT AC. Flow control systems may operate the cooling system and method through one or more isolated cooling system loops, and may include sensors, valves, and other flow control means to optimize operation and utilization of the cooling system and method, as well as capture of thermal energy from a NTAC.

This application claims the benefit of the filing date of U.S. Provisional Patent Application No. 63/007,945 for “Cooling Systems and Methods for Nuclear Thermionic Avalanche Cells” filed on Apr. 9, 2020.

### BACKGROUND

The present invention relates to direct energy conversion systems referred to as “Nuclear Thermionic Avalanche Cells” (NTACs). The NTACs are described in detail in U.S. Pat. No. 10,269,463. The NTACs provide a significant improvement over prior devices; specifically nuclear batteries or nuclear capacitors. The prior nuclear devices harness electrons from the valence band of materials but do so using the low energy capacity of the alpha and beta particles. The energy and number of beta particles emitted from a radioactive decay process are very small, resulting in the conversion systems using these beta particles having very small power densities.

In addition, a nuclear battery subsidizes the beta decay electrons and the alpha particles to generate electron disparity of a p-n junction within the frame of only the valence band of electrons in the material utilized as an electron source. As a consequence, these nuclear batteries only render a low energy density system. As a result, thus far nuclear batteries, while ubiquitous, have had fairly limited uses such as such as in spacecraft, pacemakers, underwater systems, remote sensors and automated scientific applications.

The NTAC as described in the '463 patent resolved this problem by harnessing the intra-band electron potential wells in materials having large differences between the intra-band electron potential wells and the valence band electron potential wells. This results in energy densities as much as five orders of magnitude higher than prior art nuclear batteries. The NTAC can also utilize radioactive waste, providing a means to harvest significant amounts of energy from what is currently being treated as spent fuel that must be stored in a safe manner. The power generated by the NTAC devices creates opportunities for the use of powerful, long-lasting (as much as thirty year life span) power sources that can be utilized for such things as large-scale space exploration, electric propulsion for aircraft, electric vehicle operation, autonomous residential power units, commercial dedicated power units, grid supplements, many DOD and DOE applications, as well as propulsion power for ships and submarines.

Such batteries, however, are reliant upon the thermal agitation of electrons. The greater number of electrons agitated by radiation, and the greater the energy densities, the greater amount of heat that is generated in the process. Not only is heat generated during use of nuclear batteries, but because nuclear batteries are always “on” (i.e., always emitting γ radiation during the decay life of the radiation source, and therefore always generating heat whether the resulting electrical energy is being utilized or not), heat dissipation must be addressed in the new, high-output batteries such as those described in the '463 patent. Regardless of whether the power is “on” or “off,” the power load terminals of the NTAC are always charged with high electrical potential. When electrons energized and liberated through the coupling process with high energy photons and electrons are not circulated through a load circuit, the accumulating thermal energy at NTAC system increases the system temperature. And the coupling process of materials with high energy gamma photons does fully use the incident energy of photons or electrons. The rest contributes as a thermal energy to raise the system temperature.

This is a new problem; the prior art nuclear batteries were, as noted, of low efficiency and heat dissipation was therefore not a problem that needed to be addressed. Heat control/dissipation is therefore a significant problem in the more productive nuclear batteries such as those described in the '463 patent.

The current patented NTAC designs pose issues with thermal loading inside the “always on” device and with extracting all the electrons created inside the device that are necessary for achieving the energy density. Both thermal loading and electrical output pose huge application issues for the current patented NTAC designs. All energy to be extracted by current NTAC designs is by harvesting electrons to create electrical energy that can be electrically conducted to areas outside the NTAC device for use by other devices that are powered only electrically (i.e., electronics). Whether electrons energized and liberated through the coupling process with high energy photons and electrons are circulated or not through a load circuit, thermal energy accumulates in the NTAC device as a result of resistivity by inelastic collision of energetic electrons that increase the system temperature. In addition, the coupling process of materials with high energy gamma photons does not fully use the incident energy of photons or electrons. Therefore, the rest contributes as a thermal energy to raise the system temperature.

The active cooling of NTAC devices has not been considered before. In addition, harvesting of thermal energy from NTAC devices for other uses, i.e., such as running steam turbines, has also not been considered. Given the large amount of unused thermal energy generated by NTAC devices that goes unused, a method of both cooling NTAC devices while simultaneously capturing thermal energy results in a device that can operate as a hybrid thermal and electrical power generator.

It is therefore an object of the present invention to provide an active cooling system and method for the insulator and core radiation source in nuclear thermionic devices.

It is a further object of this invention to provide a means and method for capturing thermal energy from nuclear thermionic devices.

It is yet a further object of the present invention to provide a modified nuclear thermionic device which is scalable and provides enough power to be used in applications such as large scale space exploration, electric propulsion for aircraft, electric vehicle operation, autonomous residential power units, commercial dedicated power units, grid supplement, many DOD, DOT, DOE and civilian programs, as well as propulsion power for ships and submarines.

It is yet a further object of the present invention to provide devices and methods for generating electrical and thermal power from spent nuclear material.

It is yet a further object of the present invention to provide a modified nuclear thermionic avalanche cell for sustained long-term high energy production.

### BRIEF SUMMARY OF THE INVENTION

The invention as described herein is a cooling method and benefits of Multi-NTAC layers. The NTAC operates continuously without stopping capability since it uses gamma ray radiations and/or energetic electrons which are emanated from the decay processes of radioactive materials. The innovation described herein maximizes energy output of current patented NTAC device designs, alleviates thermal loading issues inside NTAC while increasing the flexibility of both the design of NTAC devices and the system using it while eliminating integration issues with those systems that would use NTAC as a source of power.

The cooling method described herein provides not just maximization of energy output of NTAC devices, but also provides means to harness the thermal energy created by NTAC devices such that NTAC devices may provide hybrid power-production of both electrical and thermal energy. The purpose of this innovation is several fold: 1) to mitigate thermal issues inside NTAC while extracting to the maximum extent possible the thermal energy created by the NTAC device; 2) not relying solely on electrical conductivity or conversion of thermal energy to electrons and therefore electricity that can be transmitted out of the NTAC device to external areas of use; 3) converting the high temperatures inside the NTAC into usable mechanical power via water and/or other transport fluid; thus 4) giving rise to a hybrid propulsion engine that delivers both electrical power and mechanical torque to the system being powered.

Distributed NTAC layers imbedded with isotope layers as described herein give rise to several advantageous features: (1) more distributed emissions of high energy photons and high energy beta particles from a number of thin isotope layers that reduces the coupling probability within inter-atomic structure of isotope source material, (2) capture and conversion of the most of high energy photons and/or beta particles by multi-NTAC layers without leakage of residual radiation, thus requiring minimal radiation protection, (3) effective emission of avalanche electrons from the combined structure of thin layered radiation source and emitters into vacuum gap by reducing internal scattering within atomic structure of isotope source and emitter materials, (4) essentializing the high order interactions within inter-atomic structure of thinly layered isotope itself and emitters of NTAC for liberating more electrons, and (5) making a distributed thermal load on each layer. These advantage features of multilayered NTAC can be translated into higher efficiency system. However, the portion of energy received is remained as thermal and raises the temperature of NTAC system unless the thermal energy is removed.

In an embodiment of the present invention, a NTAC device is modified by adding a fluid flow cycle in an actively controlled flow network that flows through the NTAC device where the fluid temperature is elevated and the fluid flows out of the NTAC device, both providing heated fluid or steam as an energy source while cooling the NTAC device.

In another embodiment of the present invention, the temperatures of individual or groups of cooling channels may be monitored (e.g., using thermocouple sensors). And modifications of the actively controlled flow network are contemplated wherein individual or groups of cooling channels are physically isolated from other individual or groups of cooling channels and wherein the flow of coolant is independently controlled for those isolated individual or group cooling channels. For example, in particular applications it may be advantageous to individually control the flow of cooling water in separate layers of a NTAC device. Because there will likely be temperature variations in the NTAC layers, it would be advantageous in some applications to ensure that there is uniformity of temperature throughout the NTAC. In other applications, it may be that temperature variations are desired, and so the ability to control individual or groups of cooling channels independent of others would be necessary. The combination of independent control systems and sensors will allow such configurations and still be embodied within the scope of the present invention.

### DESCRIPTION OF THE DRAWINGS

FIG. 1 shows partial cutaway view of a cylindrical NTAC device with cooling channels disposed within γ-radiation sources and insulators located within the NTAC.

FIG. 2 shows a cutaway view of a cylindrical NTAC layer with cooling channels disposed within the layer.

FIG. 3 shows a view of a top cooling disk in accordance with an embodiment of the present invention.

FIG. 4 shows a view of a bottom cooling disk in accordance with an embodiment of the present invention.

FIG. 5 shows a view of a cooling disk in accordance with an embodiment of the invention.

### DETAILED DESCRIPTION OF THE INVENTION

The present invention provides a hybrid power production unit with both electrical and mechanical energy outputs through the addition of a fluid flow system in an actively controlled fluid flow network in a NTAC device. The fluid flow system performs two functions. First, it serves to cool the NTAC, allowing the device to remain within safe operating temperatures even when the device is not connected to an electrical load. Second, the fluid flow cycle allows for the capture of thermal energy generated by the NTAC, allowing the NTAC to provide both electrical and thermal power outputs.

The type and number of fluid flow systems may be tailored to the specific application for distributing both electrical and mechanical outputs of the NTAC devices to the system requiring power. The design and control of the fluid flow systems may be tailored to specific NTAC designs and uses, such as designing the fluid flow system to address a NTAC device design that may be susceptible to fatigue life thresholds that are unacceptable using higher temperatures and/or pressures. In addition, various fluids may be utilized depending upon the same type of parameters. For example, in some applications, viscous fluids or gases may be required to address system requirements or desired output of thermal energy. In some applications, thermal energy considerations may require the use of fluids in a broad range of states and chemistry. In addition, operation and control of the NTAC device itself may require the use of a fluid that is either gaseous or liquid and may have a variety of properties that are desirable for a particular application.

As a result, the exemplary fluid flow system as described herein, while relating to the use of H₂O as an exemplar, should not be construed to be limiting. It will also be understood that, while the exemplar described herein captures thermal energy for both cooling and use as an energy source in addition to the electrical energy source, the invention described herein may be utilized for the purpose of cooling a NTAC device without the need to capture thermal energy.

In the embodiment described herein, the fluid is directed by water pumps, valves, and other pressure flow network components. Those components are preferentially powered directly by the electrical output of the NTAC device, such that external power supplies, if including, are included for redundancy only but the overall system itself is self-contained and requires no external power sources. This is especially true in NTAC devices, where the electrical power is robust and, when isolated from external power distribution and control systems, unlikely to be subject to failure requiring external power supplies to operate systems relied upon by a NTAC system. As noted above, however, the fluid utilized in the present invention may be chosen from the group of any substance capable of flowing through a cooling system and absorb thermal energy from the NTAC system. Therefore, it will be understood that, while the embodiment disclosed herein contemplates fluid flow systems and components suitable for water, it is not a limitation of this invention and flow systems and components that are suitable for other fluids may be utilized where those different fluids are desired.

The embodiments herein are also related to other components used in standard locomotion drives and nuclear power plants (i.e., turbines) to convert steam to mechanical motion. In one example, steam and/or heated fluid from a NTAC device may provide thermal energy to rotate turbines or similar energy conversion means to create mechanical energy, such as drive motion that may be harnessed for such applications as direct transmission to vehicle drive trains and/or directly to the wheels or propeller (if aquatic environment) independently. As a further benefit of the present invention, the mechanical energy harnessed from the present invention could be applied, for example, to provide mechanical energy to apply to vehicles for wheels, propellers, or the like to augment electrical power from the NTAC device already being utilized for operation of the drive mechanisms of such vehicles.

In a system where the thermal energy is not utilized for an external (i.e., outside of the NTAC system cooling) purpose, or in systems where the thermal energy output exceeds the thermal energy demand of a particular system and/or external purpose, it is necessary to provide radiative means for dissipating the thermal energy. A thermal radiative device (radiator) is used as needed to help regulate the thermal loading in the integrated system. For example, in the present embodiment, steam relief valves, overflow and replacement water reservoirs may be present to dissipate the excess thermal energy, providing means to radiatively release the excess thermal energy either to the environment or through some other means. Such means are known in the art and are therefore not described in detail herein. In other applications, such as those involving wet or aquatic environments, the radiative means may provide more efficiency depending upon the characteristics of the wet and/or aquatic environments in which the embodiments are used. The processes of convection and conduction of heat are also included in this invention.

For the purposes of this disclosure, it is assumed that the NTAC is configured in a common structure wherein the radiative source is located within the center portion of a cylindrical structure, and surrounding that center portion are cylindrical emitter, insulating, and collector layers. Other configurations and/or shapes may be utilized without deviating from the intent and scope of this invention. The isotope configuration may include more than a single isotope chamber at the center of the device.

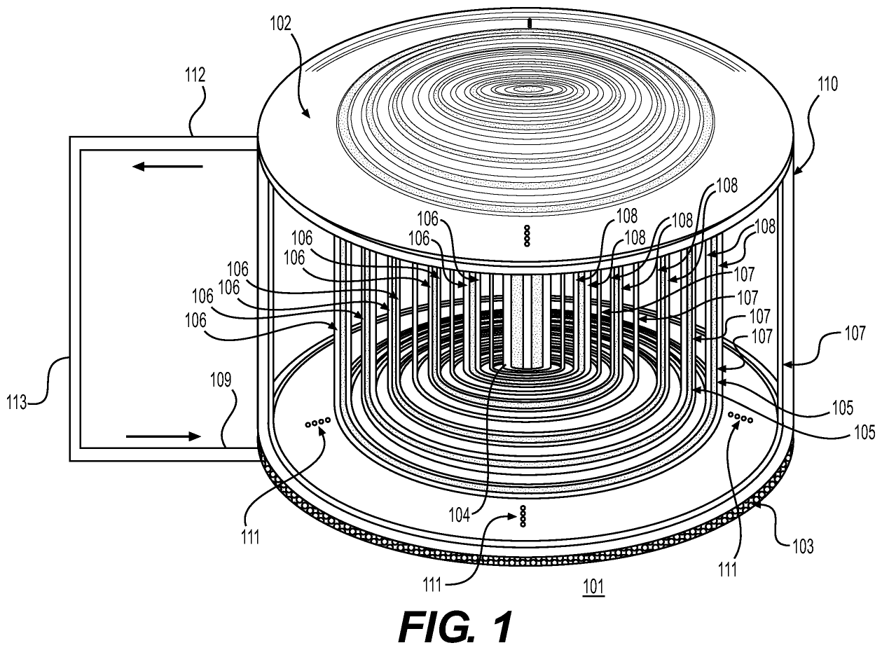

Referring now to FIG. 1, the invention as described herein is shown in the cylindrical shell of a common design of a nuclear battery generator in accordance with the prior art described above and the present invention. A NTAC is comprised of one or more shells of materials with a radiative source contained within the center portion of the NTAC. It will be understood that the embodiment shown herein is an exemplar embodiment, and should not be understood to encompass a limited scope of the invention claimed herein.

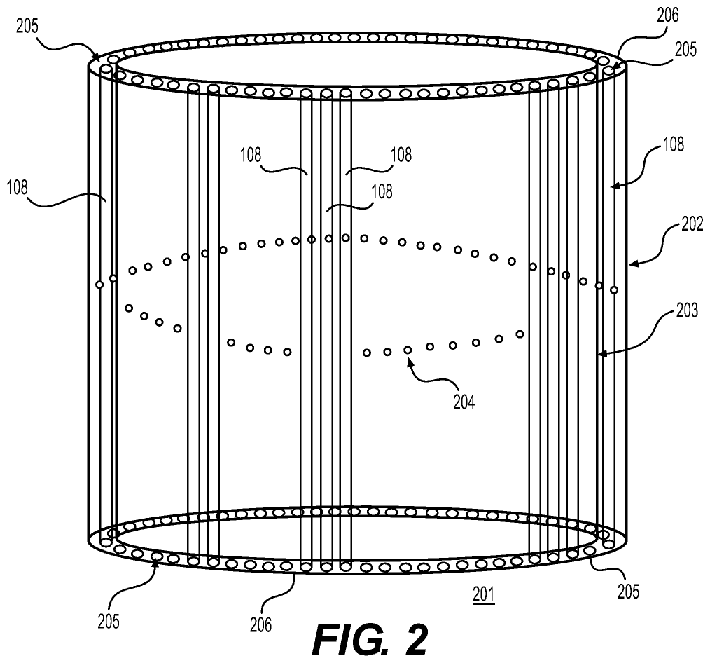

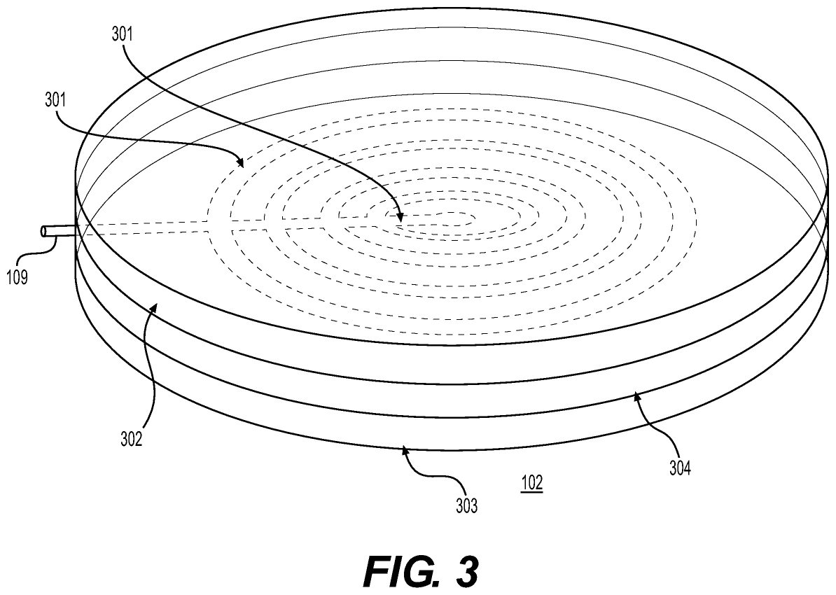

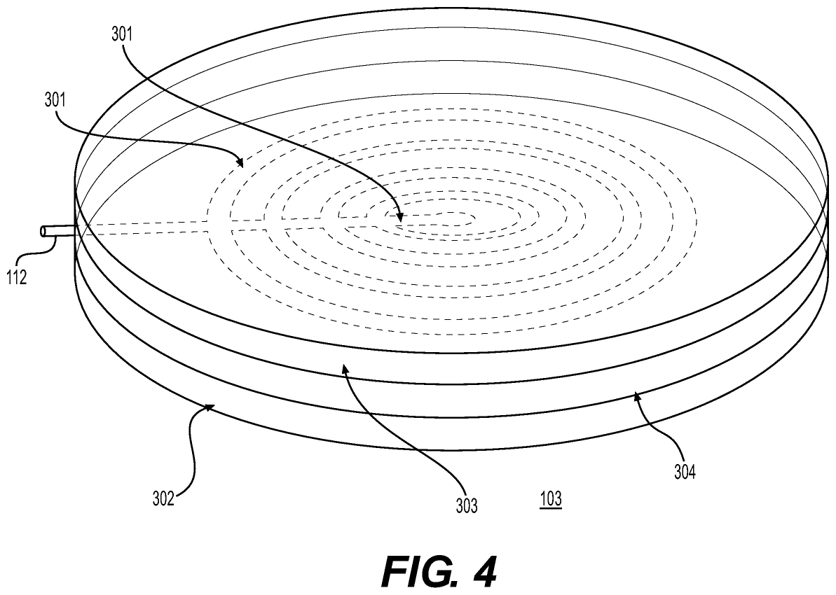

FIG. 1 shows a partial cutaway of a multilayered NTAC 101 which is shown as a Metallic Junction Thermoelectric Generator with radiation shielding 110. The NTAC incorporates a fluid flow system that comprises a top cap 102 and a bottom cap 103, a central radiative energy source 104 that is surrounded by one or more concentric shells comprising one or more insulator layers 105, one or more emitter layers 106, and one or more collector layers 107. The fluid flow system also comprises coolant channels 108 (as shown, an exemplar of cooling channels, which may comprise one or more cooling channels per insulator layer 105 and/or radiative layer 106), the channels 108 being disposed within the layers that may be comprised of the insulator layers 105. The channels 108 are, in the embodiment disclosed herein, disposed vertically within the insulator layers 105. Cooling water flows through an inlet 109 into the bottom cap 103 (further described in FIG. 3, 103) and through cooling channels (FIG. 3, 301) disposed within the bottom cap 103. The bottom cap 103 further comprises openings 111 connected to the cooling channels 108. In the cutaway view as shown in FIG. 1, representations of the openings 111 for additional fluid flow channels in additional insulator layers 105 and emitter layers 106 are shown in FIG. 1 at 111. The openings 111 are shown in the cutaway without connection to channels 108 for descriptive purposes. It will be understood that in an operating NTAC, each opening 111 will connect to a channel 108 disposed within an insulator layer 105. Further detail of this configuration is shown in FIG. 2. It will also be understood that the number of fluid flow channels 108 and configurations are going to be guided generally, by the number of emitter layers 106 and insulator layers 107 defined by and contained within a particular NTAC design and thermal energy practices. Cooling water flows up through the channels 108 into the top cap 102 that is configured in the same manner as the bottom cap 103 as further shown in FIG. 4. The water flows through cooling channels (FIG. 4, 401) and out through an outlet 112.

The inlet 109 and outlet 112 are connected to the appropriate control devices and structures (represented by a closed loop 113) configured for a desired use and functioning as a thermal dissipator. If the now-heated water is not to be utilized to capture the thermal energy from the NTAC, the control devices and structures will be configured to allow the heated water to flow through a radiator, where necessary, to dissipate the heat, cooling the water for return to the NTAC. As discussed above, there are myriad uses that can be made of the thermal energy captured from the NTAC. To meet specific use demands or requirements, the thermal dissipater may be configured for a specific application. The thermal dissipater could be an active cooling radiator, or a passive cooling with radiation fins, or can be another power conversion cycle by using high energy carrying high pressure steam, or can be a space heating purpose, or any other applications that uses radiation, convection, conduction, or other means. The thermal dissipation configuration described herein and shown in FIG. 1 should not be considered to be limiting.

Whichever coolant is chosen, the coolant passes through the channels to lower the temperature of the cylinder of NTAC γ-ray source and insulators. Since the thickness of insulator layers with water flowing channels is relatively thin, the coolant channels are small too. Therefore, in this example, the water has negligible absorptive radiation coupling. Since water as a coolant is a compound of hydrogen and oxygen which have very low radiation cross sections, that is why there will be a negligible ionization while passing through the channels. Although the ionization of water occurs through the channel, but the recombination process prevails, there are no direct harms and damages by gas phase of water or ionized hydrogen and oxygen. For a long run, there will be a likely chance of oxidation process of radiation source materials, however the oxidation does not change the nuclear decay process at all. The coolant channels can be built on the radiation source, such as ⁶⁰Co. However, ¹³⁷Cs and ²²Na may not be suitable for water channels to be built within unless these materials exist as a chemical compound without chemical reaction with water. For ¹³⁷Cs and ²²Na cases, the different type of coolants can be used. Or otherwise, the coolant channels of these radiation sources can be specifically built with quartz or alumina for the purpose of inhibiting the direct contact of ¹³⁷Cs or ²²Na with the coolant. Furthermore, however packaged, whether in a vile or other container or compartment, ¹³⁷Cs and ²²Na and any isotope not structurally stable, whether particles, powder, liquid, or solid, can be cooled via cooling its container or compartment by way of this invention.

The cooling requirement is not only for the γ-ray source, but also for the NTAC body that is a combination of collector, insulator, and emitter layers. The coolant channels built in insulators do not have the problem of chemical reactions with coolant, unlike ¹³⁷Cs and ²²Na. Accordingly, the coolant channels of the insulator material can be used without any restrictions.

The top and bottom caps of a NTAC system, as shown in FIGS. 1, 3, and 4 are designed to circulate the coolant through the bottom cap via the wall channels to the top cap.

FIG. 2 shows a cutaway view of cylindrical NTAC layer 201 with cooling channels 108 disposed within the layer 201. As noted above, both insulator and emitter layers are structured to include the cooling channels 108, and so FIG. 2 is representative of both an insulator and an emitter layer. The layer 201 has an outer surface 202 and an inner surface 203. As shown, the cooling channels 108 are disposed within the layer 201 between the outer surface 202 and inner surface 203. The channels 108 terminate in openings 205 at both top and bottom ends 206 of the layer 201. It will be understood that in the embodiment as shown, the layer 201 is symmetric in that the thickness between the outer surface 202 and inner surface 203 is the same for all parts of the layer 201. In addition, the inner diameter and outer diameter of the layer 201 is constant at all points of the layer 201 as well. It will be understood then that the top and bottom ends 206 are equivalent, and the layer 201 may be configured with a top cap (FIG. 1, 102) and bottom cap (FIG. 1, 103) mated to either end. As shown in FIG. 1, what distinguishes the top and bottom of the invention as described herein is a function of the flow of the coolant. Coolant enters the bottom cap 103 and exits the top cap 102.

Because FIG. 2 is a cutaway view, additional channels 108 are represented by showing the circumference 204 of channels 108 not shown in FIG. 2. It will be understood that the size, number, and spacing of channels 108 will be determined by the engineering requirements of a particular NTAC design, and FIG. 2 is meant to be representative only in that regard.

The top cap as shown in FIG. 3 illustrates the circulation channels 301 incorporated as a center portion 304 in between the radiation shielding cap 302 on top and the metallic junction TE (MJ-TE) 303 at the bottom. The circulation channels 301 are disposed within the center portion 304. All three parts are integrated together to form a top cap 102 for a NTAC system. The combined parts integrated into the cap provide additional shielding to hinder radiation from exiting the device. The coolant outlet 109 is part of the circulation channels 301. The circulation channels 301, while enclosed within the top cap 102, are open through the MJ-TE 303, and are configured to provide open flow of coolant between the channels 301 and the channels (FIG. 2, 108) disposed within a layer 201. When assembled, the MJ-TE 303 is mated to the layer 201 as shown in FIG. 1.

The bottom cap 103 as shown in FIG. 4 has the identical design feature of the top cap 102, except for the arrangement reversely placed with the MJ-TE 303 at the top, the cooling channels 301 in the middle portion, and the radiation shielding portion 302 at the bottom. In operation, the only difference between the bottom cap 103, as compared to the top cap 102, is the flow direction of coolant. As such, the bottom cap 103 includes a coolant inlet 112 where the top cap 102 includes a coolant outlet (FIG. 3, 109).

The MJ-TE 303 is a direct energy conversion technology based on thermoelectric principle. As noted above, the MJ-TE 303 of both the top cap 102 and the bottom cap 103 has one or more coolant channels 301 that are open through the MJ-TE 303 to correspond to the number of layers 201 that comprise the NTAC's structure, which may vary. For both the top cap 102 and the bottom cap 103, the coolant channels 301 are configured to provide open flow of coolant through the openings 205 at both top and bottom ends 206 of a layer 201.

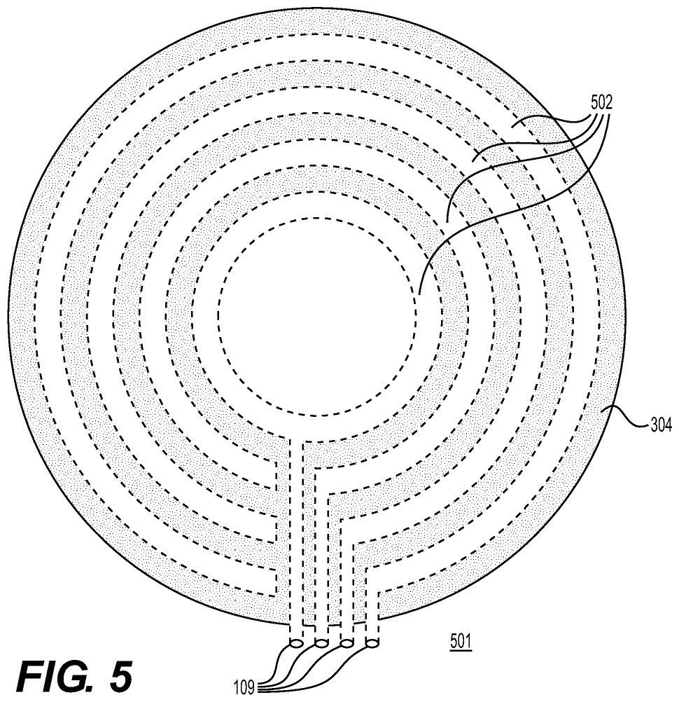

FIG. 5 shows a cutaway view of a center portion 304. As noted above, the center portion 304 design may be the same for both the top cap 102 and bottom cap 103. In the configuration shown in FIG. 5, the center portion consists of two or more isolated coolant channels 502 which, unlike those shown in FIGS. 3 and 4, are not interconnected with other isolated coolant channels 301 disposed within the center portion 304. Each of the isolated coolant channels 502 shown in has its own inlet/outlet 109 (outlet if for a top cap 102 and inlet if for a bottom cap 103). The isolated coolant channels 502 may therefore be connected to flow control systems to operate them individually or in groups. Such flow control systems could be as simple as including thermostats in the flow control systems. Thermal sensors, such as thermocouples, may be disposed within layers 201 with coolant channels 108. The inlets 109 for coolant in the bottom cap 103 may further including flow control means such as gate valves or other means to stop and/or control the flow of fluid into a particular layer 201. As with the top cap 102 and bottom cap 103 described above, the isolate coolant channels 502 correspond to a particular layer 201 and are configured to provide open flow of coolant through the openings 205 at both top and bottom ends 206 of a layer 201.

Although not shown, MJ-TE devices are also included as part of the exterior shell of a NTAC to harness the electrical power generated by a NTAC by converting the thermal energy which would be, otherwise, wasted. Outside of the exterior shell MJ-TE portion is a portion with coolant channels constructed in the same manner as the layers 201, and the radiation shielding lead blanket at the outer most portion of the NTAC shell is a radiation shielding lead blanket. It will be understood that this is a standard NTAC configuration, having MJ-TE portions and radiation shielding lead blankets; those configurations are understood to be standard only, and may be excluded or modified as needed for a particular application without deviating from the scope and intent of the present invention.

The sizes of coolant channels are eventually designed to allow a certain amount of coolant to capture and remove thermal energy from NTAC. The flow rate of coolant and the size of coolant channels are determined by the power output capacity of NTAC and the mechanism of thermal dissipater. Accordingly, no exact size and flow rate of coolant are quantified in this invention disclosure.

The invention described herein solves significant problems, especially for mining equipment and mobile devices that would already have a locomotive drive system or requiring the output of the NTAC device to create mechanical motion, whether electric motors on wheels. The electric drive motors on the wheels of the mobile device would consist of heavy electro-mechanical coiled motors. So, based upon current designs and materials of NTACs, from a mass comparison there may be little difference. However, with respect to large terrestrial mining and construction equipment, high torque that can be created using diesel and other combustion engine drives, and hydraulic motors may be preferred over electric motors for producing the large forces necessary for mining. The proposed hybrid power concept mentioned by this innovation allows the torques to be created by combining in various ways the electrical and mechanical power outputs intended by this innovation.

The invention described herein is intended to be an exemplar of a configuration in accordance with the invention. It should not be construed to be limiting except as required to achieve the purposes of the invention.

What is claimed is:

1. A Nuclear Avalanche Cell comprising:
one or more shells,
a central radiative energy source, and
a fluid flow system.

2. The Nuclear Thermal Avalanche Cell of claim 1 further comprising radiation shielding.

3. The Nuclear Thermal Avalanche Cell of claim 1 further comprising a top cap and a bottom cap.

4. The Nuclear Thermal Avalanche Cell of claim 2 wherein the closed fluid flow loop further comprises flow control devices.

5. The Nuclear Thermal Avalanche Cell of claim 2 wherein the closed fluid flow loop further comprises a thermal dissipator.

6. A Nuclear Thermal Avalanche Cell comprising:
one or more shells,
radiation shielding,
a top cap,
a bottom cap,
a central radiative energy source, and
a fluid flow system disposed within the one or more shells, the top cap, and the bottom cap.

7. The Nuclear Thermal Avalanche Cell of claim 4 wherein the fluid flow system further comprises an inlet and an outlet, the inlet and outlet being connected to a closed fluid flow loop.

8. The Nuclear Thermal Avalanche Cell of claim 5 wherein the closed fluid flow loop further comprises flow control devices.

9. The Nuclear Thermal Avalanche Cell of claim 5 wherein the closed fluid flow loop further comprises a thermal dissipator.

10. The Nuclear Thermal Avalanche Cell of claim 1 wherein the one or more shells are disposed concentrically around the central radiative energy source;
the central radiative energy source comprises an outer wall and an inner portion with a radiative source disposed within the inner portion;
the one or more shells comprising one or more insulator layers, one or more emitter layers, and one or more collector layers; and
the fluid flow system is comprised of one or more coolant channels disposed within the top cap, one or more coolant channels disposed within the bottom cap, one or more openings disposed within the top cap and one or more openings disposed within the bottom cap wherein the one or more openings of the top cap and the one or more openings of the bottom cap connect the coolant channels disposed within the one or more shells to the one or more cooling channels disposed within the top cap and bottom cap, an inlet disposed within the bottom cap, an outlet disposed within the top cap, and the inlet and outlet connected to a closed fluid flow loop.

11. A Nuclear Avalanche Cell comprising:
one or more shells;
a central radiative energy source;
a fluid flow system;
wherein the one or more shells are disposed concentrically around the central radiative energy source;
the central radiative energy source comprises an outer wall and an inner portion with a radiative source disposed within the inner portion;
the one or more shells comprising one or more insulator layers, one or more emitter layers, and one or more collector layers; and
the fluid flow system is comprised of one or more coolant channels disposed within the top cap, one or more coolant channels disposed within the bottom cap, one or more openings disposed within the top cap and one or more openings disposed within the bottom cap wherein the one or more openings of the top cap and the one or more openings of the bottom cap connect the coolant channels disposed within the one or more shells to the one or more cooling channels disposed within the top cap and bottom cap, an inlet disposed within the bottom cap, an outlet disposed within the top cap, and the inlet and outlet connected to a closed fluid flow loop.

12. A cooling system and method for Nuclear Thermionic Avalanche Cells (NTACs) comprising a cooling system through which a coolant is circulated through the NTAC and wherein the NTAC is comprised of a central radiative source generating particles, those particles being from the group comprising and may include β and/or γ particles;
the NTAC further comprised of one or more distributed layers exterior to the central radiative source, those layers chosen from the group comprising insulator layers, emitter layers, and collector layers and wherein the layers have end portions, and wherein the NTAC device harnesses electrical energy from the interaction of the β and/or γ particles with the one or more layers;
the NTAC device further comprising cooling channels disposed within the group comprising the one or more insulator layers and one or more emitter layers and wherein the cooling channels are capable of having the coolant flowing through them from one end portion to another end portion of a layer, the coolant chosen from the group of materials suitable for removing thermal energy from the NTAC;
the cooling channels disposed within the one or more insulator layers and one or more emitter layers having openings at the end portions of the one or more insulator layers and one or more emitter layers;
the NTAC further comprising a top and bottom cap attached to the end portions of the one or more layers of the NTAC, the top and bottom caps having cooling channels disposed within them which are sealed to the exterior of the top and bottom caps but open to and connected with the openings of the cooling channels located at the end portions of the one or more insulator layers and one or more emitter layers such that coolant flow through the NTAC may be continuous;
the top and bottom caps further comprising a thermoelectric direct energy portion connecting to the end portions of the layers;
the top cap further comprising one or more outlets for the coolant and the bottom cap further comprising one or more inlets for the coolant, the one or more outlets and one or more inlets being fluidly connected to one or more coolant flow systems and one or more thermal emitters;
the one or more coolant flow systems further comprising means to move the coolant through the coolant flow system and further comprising means to control whether or not the one or more cooling channels receive coolant and the rate at which the one or more cooling channels receive coolant;
the one or more coolant flow systems and one or more cooling channels further comprising one or more thermal sensing means, the one or more thermal sensing means providing feedback signals to the one or more fluid flow control systems and the one or more fluid control systems having means to adjust fluid flow based upon the feedback signals;
the one or more fluid control systems utilizing the electrical energy harnessed from the NTAC as electrical power for means to move the coolant and means to control whether the one or more cooling channels receive coolant;
the one or more coolant flow systems further comprising means to dissipate the thermal energy removed from the NTAC, said means to dissipate the thermal energy chosen from the group comprising one or more radiative means and one or more thermal energy conversion means; and
the one or more thermal energy conversion means providing conversion of thermal energy to mechanical energy.

13. A method for cooling a Nuclear Thermal Avalanche Cell, comprising: flowing coolant through coolant channels disposed within a NTAC, the coolant being flowed into the coolant channels through an input port disposed within a bottom cap affixed to the NTAC, causing the coolant to flow through coolant channels disposed within one or more shells within the NTAC, the coolant absorbing thermal energy from the NTAC, the coolant then flowing through coolant channels disposed within a top cap affixed to the NTAC, the coolant then flowing out of the NTAC through an outlet port disposed within the top cap, the coolant then flowing through a fluid flow loop, and having means disposed within the fluid flow loop for circulating the coolant through the fluid flow loop and the coolant channels disposed within the bottom cap, NTAC, and top cap.

14. The method of claim 12 wherein the fluid flow loop further comprises thermal dissipation means.

15. The method of claim 13 wherein the thermal dissipation means further comprises means for capturing thermal energy from the thermal dissipation means.

16. A method for cooling a Nuclear Thermal Avalanche Cell, comprising: flowing coolant through coolant channels disposed within a NTAC, the coolant being flowed into the coolant channels through an input port disposed within a bottom cap affixed to the NTAC, causing the coolant to flow through coolant channels disposed within one or more shells within the NTAC, the coolant absorbing thermal energy from the NTAC, the coolant then flowing through coolant channels disposed within a top cap affixed to the NTAC, the coolant then flowing out of the NTAC through an outlet port disposed within the top cap, the coolant then flowing through a fluid flow loop, and having means disposed within the fluid flow loop for circulating the coolant through the fluid flow loop and the coolant channels disposed within the bottom cap, NTAC, and top cap, wherein the fluid flow loop further comprises thermal dissipation means and further comprises means for capturing thermal energy from the thermal dissipation means.
